(19) United States
(12) Patent Application Publication
(10) Pub. No.: US 2026/0140426 A1
(43) Pub. Date: May 21, 2026

(54) OPTICAL ARRANGEMENT AND METHOD OF REDUCING REFLECTIONS IN CAMERA, AND CAMERA

(71) Applicant: Varjo Technologies Oy, Helsinki (FI)

(72) Inventors: Perttu Keinänen, Turku (FI); Mikko Ollila, Tampere (FI)

(73) Assignee: Varjo Technologies Oy, Helsinki (FI)

(21) Appl. No.: 18/953,449

(22) Filed: Nov. 20, 2024

(51) Int. Cl. G03B 11/00

(52) U.S. Cl. CPC G03B 11/00

(57) ABSTRACT

An optical arrangement for reducing reflections in camera includes image sensor with a light-sensitive surface and a filter arranged at a first distance from the light sensitive surface along an optical axis of optical arrangement. The filter includes a first curved surface facing a light-sensitive surface, and a second surface opposite to the first curved surface. The light-sensitive surface is configured to receive light and reflect received light towards the filter. The filter is configured to reflect light between a first curved surface and a second surface inside the filter. Reflections between the filter and the light sensitive surface are reduced.

### TECHNICAL FIELD

The present disclosure relates to optical arrangements for reducing reflections in cameras. Moreover, the present disclosure relates to cameras comprising the optical arrangement. Furthermore, the present disclosure relates to methods of reducing reflections in cameras.

### BACKGROUND

Depth sensing technology has become increasingly important across various applications, such as augmented reality, robotics, autonomous vehicles, and similar. As these technologies evolve, the need for an accurate and reliable measurement of distances has intensified. Typically, cameras, for example, such as wide field of view Indirect Time of Flight (ITOF) cameras are commonly used in these applications due to their ability to capture depth information by measuring time it takes for light to travel to an object and back. However, in the field of depth sensing, particularly with the ITOF cameras, a significant technical challenge arises from phenomenon of internal reflections within camera system. These reflections can occur when bright, nearby objects reflect excessive amounts of the light, causing unwanted signals that interfere with ability of the cameras to accurately measure distances. This issue becomes particularly pronounced in high-illumination environments, where contrast between illuminated objects and their surroundings can lead to ghosting and glare. For example, fat finger problem occurs when reflections from nearby bright surfaces distort depth measurements of an intended target. Thus, the resulting false signals not only degrade quality of captured images but also compromise precision of depth measurements, making it difficult for said cameras to function effectively in practical applications.

Conventionally, existing solutions to address these reflection issues primarily involve use of flat bandpass filters combined with complex anti-reflection coatings. These coatings are designed to minimize reflections at filter surface, while various methods are employed to enhance optical alignment of lens system. Typically, one common approach involves extending total optical path length to ensure that light rays enter the flat bandpass filter as perpendicularly as possible. However, despite these efforts, the effectiveness of the flat bandpass filters in reducing reflections remains limited. This design strategy contributes to a significant increase in overall size of the camera system, which can be a critical drawback in applications where compactness is essential. The inherent flatness of the flat bandpass filters can still result in significant internal reflections, particularly in configurations where the flat bandpass filter is parallel to sensor surface. This can lead to a failure to adequately mitigate ghosting and glare, thereby hindering an overall performance of the cameras in demanding conditions. Moreover, the complexity of the existing anti-reflection coatings and requirement for precise optical design can result in increased manufacturing costs and extended development times. While these methods have made strides in improving the overall performance of the cameras, do not fully resolve the underlying issues of internal reflections.

Therefore, in light of the foregoing discussion, there exists a need to overcome the aforementioned drawbacks.

### SUMMARY

The aim of the present disclosure is to provide an optical arrangement, a camera comprising the optical arrangement, and a method for reducing reflections in a camera to enhance quality of an image by minimizing optical artifacts and improving transmission of light to an image sensor, thereby achieving clearer, higher-contrast images with reduced glare and unwanted reflections. The aim of the present disclosure is achieved by an optical arrangement for reducing reflections in a camera, a camera comprising the optical arrangement, and a method for reducing reflections in a camera as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates a schematic illustration of an optical arrangement for reducing reflections in a camera, in accordance with an embodiment of the present disclosure;

FIGS. 2A and 2B illustrate a graphical representation of an exemplary experimentation part conducted for comparing performance of a flat bandpass filter and a curved bandpass filter in terms of an irradiance distribution within an optical arrangement, in accordance with an embodiment of the present disclosure;

FIG. 3 illustrates a block diagram of an architecture of a camera, in accordance with an embodiment of the present disclosure; and

FIG. 4 illustrates steps of a method of reducing reflections in a camera, the method implemented by an optical arrangement, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides an optical arrangement for reducing reflections in a camera, the optical arrangement comprising:
an image sensor comprising a light-sensitive surface; and
a filter arranged at a first distance from the light sensitive surface along an optical axis of the optical arrangement, wherein the filter comprises:
   a first curved surface facing the light-sensitive surface, and
   a second surface opposite to the first curved surface,
      wherein the light-sensitive surface is configured to receive light and reflect the received light towards the filter, and wherein the filter is configured to reflect the light between the first curved surface and the second surface inside the filter, whereby reflections between the filter and the light sensitive surface are reduced.

The present disclosure provides an aforementioned first aspect for reducing reflections in the camera. By incorporating the filter with the first curved surface oriented toward the light-sensitive surface of the image sensor, the optical arrangement minimizes internal reflections between the filter and the image sensor. The curvature of the filter allows reflected light from the image sensor to be at least one of: incident on a periphery of the image sensor, not incident at all, thereby preventing direct reflection back onto the image sensor. This configuration significantly reduces occurrence of ghosting and glare in an optical device (for example, such as a camera), which are common issues in traditional flat filter designs. This optical arrangement promotes efficient light management, reducing a need for external elements or complex coatings to address reflection problems. It will also be appreciated that this optical arrangement enables for a more compact design by reducing a need to extend an optical path length, which is often required in traditional systems to minimize reflections. This simplifies a process of manufacturing the optical arrangement.

In a second aspect, the present disclosure provides a camera comprising:
an optical arrangement of the first aspect;
a lens arranged in front of the optical arrangement, wherein an optical axis of the optical arrangement coincides with an optical axis of the lens; and
a light source that is arranged to emit light, when in use;
   wherein when in use, the light source emits light, said light passes through the lens and is incident at the optical arrangement.

The present disclosure provides the aforementioned second aspect, wherein when the camera comprises the optical arrangement, said optical arrangement enhances overall performance of the camera without adding any complexity to the optical arrangement. By incorporating the optical arrangement into the camera, any reflections from nearby objects, which can cause further reflections between the image sensor and the filter, is reduced. It will also be appreciated that this optical arrangement enables for a more compact design by reducing a need to extend an optical path length, which is often required in traditional systems to minimize reflections. This simplifies a process of manufacturing the optical arrangement, thus making it easier to produce cameras that provide images with minimal to no visual artifacts. In the camera, the arrangement of the optical axis of the lens with the optical axis of the optical arrangement ensures accurate transmission of the light through the lens, effectively minimizing optical distortions and enhancing quality of an image which is being captured by the camera. This precise arrangement contributes to improved depth sensing and accuracy of the image, which is essential in applications requiring high precision. This setup minimizes internal reflections, thereby reducing the occurrence of ghosting and glare in the camera. This leads to improvement of performance of the camera in high-illumination environments or when capturing nearby bright objects, maintaining accurate depth measurements and reducing unwanted signal interference. Furthermore, it will be appreciated that the integration of the light source, the lens, and the optical arrangement simplifies overall design of the camera by reducing the need for additional optical components. This design of the optical arrangement lowers manufacturing complexity and cost while maintaining high optical performance. This compact nature of the camera makes it highly suitable for various applications requiring reliable depth sensing and high-quality capture of the image.

In a third aspect, the present disclosure provides a method of reducing reflections in a camera, the method implemented by an optical arrangement, wherein the optical arrangement comprises an image sensor comprising a light-sensitive surface, a filter having a first curved surface that faces the light-sensitive surface of the image sensor, and a second surface that is opposite to the first curved surface, the method comprising:
receiving light on the light sensitive surface of the image sensor;
reflecting the light towards the filter that is arranged at a first distance from the light sensitive surface along an optical axis of the optical arrangement; and
reflecting the light between the first curved surface and the second surface inside the filter to reduce reflections between the filter and the light-sensitive surface.

The present disclosure provides the aforementioned third aspect for reducing reflections in the camera. Herein, the received light that reflects between the image sensor and the filter is at least one of: incident on a periphery of the image sensor, not incident on the image sensor, due a curved nature of the filter. Thus, the internal reflections are minimized between the filter and the image sensor, as there is no direct reflection back onto the image sensor. The aforementioned method significantly reduces occurrence of ghosting and glare in an optical device (for example, such as a camera). The method of reducing reflections in the camera is simple, robust, and effectively enhances overall performance of the camera by minimizing an unwanted reflections, which leads to clearer images and more accurate depth measurements.

Throughout the present disclosure, the term “optical arrangement” refers to a configuration of optical components designed to manipulate and control propagation of the light. Typically, the optical arrangement includes optical elements (for example, such as lenses, filters, mirrors, image sensors, and similar) which work together to achieve desired optical effects, such as focusing, filtering, and imaging. A technical effect of the optical arrangement is that it reduces internal reflections, improves quality of the image and measures accuracy across a wide range of camera types.

Throughout the present disclosure, the term “camera” refers to an optical device specifically designed for capturing images, video, and similar, by capturing the light onto the light-sensitive surface of the image sensor. Moreover, the image may be any visual representation captured by the camera, such as photographs, live video feeds, digital projections, and similar, depending on the application requirements.

Optionally, the camera comprises at least one of: an indirect-type TOF camera, a direct-type TOF camera, an event camera, a single-wavelength camera. In this regard, the term “indirect-type Time of Flight camera” refers to a depth-sensing optical device that measures time it takes for the light to travel from the light source, reflect off an object, and return to camera sensor. The indirect-type Time of Flight (TOF) camera is advantageous in applications requiring high-resolution depth maps and is commonly used in augmented reality, robotics, autonomous navigation, and similar. It will be appreciated that the use of the indirect TOF camera along with the optical arrangement reduces internal reflections and ghosting artifacts, enhancing the depth measurement accuracy by minimizing errors caused by stray light or ghosting effects within the camera. The term “direct-type Time of Flight camera” refers to a device that directly measures the time it takes for emitted light to reflect off a target and return to the image sensor of the camera. An example of the direct-type TOF camera may be a Light Detection and Ranging (LiDAR) camera. The direct-type TOF camera is often utilized in applications requiring high-speed measurements and can operate effectively in various lighting conditions. It will be appreciated that the use of the direct TOF camera reduces the unwanted reflections from bright surfaces, enabling faster and more reliable depth measurements even in challenging environments with bright surfaces or high illumination. The term “event camera” refers to a device that captures changes in a scene at pixel level, triggering events based on an intensity variations of incoming light. Unlike conventional cameras that record frames at fixed intervals, the event camera generates asynchronous data, producing output only when changes occur in field of view. This results in high temporal resolution, reduced motion blur, and efficient data processing, making the event camera particularly useful in dynamic environments and applications such as motion tracking, gesture recognition, high-speed vision, and similar. It will be appreciated that the use of the event camera reduces internal reflections, allowing for more accurate detection of pixel-level changes and improving the efficiency of high-speed vision tasks. The term “single-wavelength camera” refers to a device that operates by capturing the light at a specific wavelength or narrow band of wavelengths, typically using filters to isolate this range. The single-wavelength camera may be utilized in applications where detection of specific spectral characteristics is essential, such as in multispectral imaging, fluorescence microscopy, material identification, and similar. It will be appreciated that the use of the single-wavelength camera reduces reflection losses and enhances clarity and fidelity of the light captured at the targeted wavelength, improving overall spectral accuracy. Examples of other types of the camera may include, but are not limited to, a hyperspectral camera, a thermal camera, a polarization camera, and similar, each designed for specific imaging requirements across diverse applications. The aforesaid types of the camera are well-known in the art. A technical effect of the aforementioned feature is that it enhances adaptability of the camera to various imaging and depth-sensing applications, ensuring performance across different environments.

In the first aspect, the term “image sensor” refers to a device that detects the light from a real-world environment at its light-sensitive surface to produce the image. The image sensor typically converts the light received into electrical signals that can be processed for various applications, for example, such as image capture, light intensity measurement, wavelength analysis, and similar. Examples of the image sensor may include, but are not limited to, photodetectors, Complementary Metal-Oxide-Semiconductor (CMOS) sensors, Charge-Coupled Device (CCD) sensors, and photovoltaic cells. The term “light-sensitive surface” refers to an area of the image sensor that interacts with incoming light. The light-sensitive surface is essential for ability of the image sensor to capture detailed images, as it directly influences factors like resolution, light absorption, and accuracy of converted digital representation. Herein, the image sensor operates by receiving the light that has passed through optical components (for example, such as lenses, filters, and similar) and interacts with the light-sensitive surface. The light-sensitive surface contains photosensitive elements, such as pixels, which detects the light and convert it into electrical signals. These signals are then processed by the camera to form the image or depth information. A technical effect of the image sensor and its light-sensitive surface is that they enable the camera to capture detailed visual and depth information with high precision, reducing noise and enhancing overall quality of the image.

In the first aspect, the term “filter” refers to an optical element that selectively modifies spectral composition of the light entering the optical arrangement. The filter is designed to either transmit or attenuate specific wavelengths of the light, enhancing quality of the light that reaches the image sensor. Examples of the filter may include, but are not limited to, a bandpass filter, a flat bandpass filter, a curved bandpass filter, a low-pass filter, a high-pass filter, a notch filter, an optical interference filter, a colour filter, a polarizing filter, and similar. The term “first distance” refers to a predetermined, measurable separation between the filter and the light-sensitive surface of the image sensor, maintained along the optical axis. The first distance is essential for optimizing optical performance of the image sensor, as it influences focusing properties and interaction of the light with the filter. By establishing the first distance, the optical arrangement maximizes light transmission efficiency and minimize optical aberrations, thereby enhancing a quality of the image. Moreover, the term “optical axis” refers to a defined line that represents a central path along which the light propagates through the optical arrangement. The filter is arranged at the first distance from the light-sensitive surface along the optical axis to optimize its effectiveness. Herein, a central axis of the filter is at the first distance from the light-sensitive surface, the central axis being perpendicular to the optical axis.

Optionally, the first distance lies in a range from 0.1 millimetres (mm) up to 10 mm. The first distance may, for example, lie in a range from 0.1, 0.2, 0.4, 0.7, 1.0, 1.5, 2.0, 3.0, 4.0, 6.0, or 9.0 mm up to 0.5, 3.0, 5.0, 7.0, 8.5, 8.8, 9.2, 9.5, 9.6, 9.9, or 10 mm. It will be appreciated that defining the range of the first distance enables for precise optimization of the optical arrangement, facilitating optimal light transmission and ensuring minimal distortion of the image which is being captured by the camera. By providing specific incremental values within this range, the optical arrangement can be fine-tuned for various applications, thereby enhancing adaptability and performance of the arrangement across different imaging scenarios. A technical effect of specifying the first distance within the range of 0.1 mm to 10 mm is that it enhances capability of the optical arrangement to balance transmission of the light and quality of the image while minimizing optical aberrations.

In the first aspect, the term “first curved surface” refers to a geometrical surface that is bulged along a centre of the filter and is oriented to face the light-sensitive surface within the optical arrangement. The first curved surface is designed to manipulate the light reflected off the light-sensitive surface of the image sensor. Notably, a curvature of the first curved surface may vary in radius, allowing it to focus or disperse the light as required by specific optical design. The term “second surface” refers to a geometrical surface that is opposite to the first curved surface within the optical arrangement. The design of the second surface enables to control internal reflections and overall optical performance of the optical arrangement, ensuring that the light is effectively managed between the filter and the light-sensitive surface of the image sensor.

In this regard, reflections between the filter and the light-sensitive surface are reduced through an unintentional interaction of the light with the first curved surface and the second surface of the filter. Specifically, the light-sensitive surface initially receives an incident light and reflects it towards the filter. Within the filter, the light encounters the first curved surface, which is designed to direct the light towards the second surface. Notably, the filter is configured to reduce unintentional reflections between the first curved surface and the second surface which are directed towards the light sensitive surface. Herein, the light reflection inside the filter between the first curved surface and the second surface is not intentional. Such unintentional reflection of light is harmful and is tried to be subtracted by using suitable absorbing filter glass in some cases (for example, such as a blue glass). Commonly, this internal reflection is reduced by using antireflection coating on at least one side of the filter. Such antireflection coating, at one or at both sides of the filter, are most commonly made with at least one dielectric coating comprising thin layers that are stacked against each other (namely, a dielectric coating stack). A number of the thin layers lies in a range of 2 to 40 layers of alternating high and low refractive index layers. Moreover, there is a descripted kind of interference in back-and-forth reflections between these thin layers in the dielectric coating stack in at least one side of the filter, which will result in desired bandpass and antireflection characteristic of the antireflection coating. Herein, a portion of the light that is reflected from the filter is any one of: incident on a peripheral region of the image sensor, not incident on the image sensor. This reduction is achieved by containing the light within the filter through controlled internal reflections, thereby preventing unwanted back-reflection towards the light-sensitive surface. This design leads to an improved clarity of the image and a higher signal-to-noise ratio by maintaining effective light transmission and minimizing stray light interference. It will be appreciated that this arrangement promotes efficient transmission of the light and minimizes optical noise, which is particularly beneficial for applications requiring high-fidelity image reproduction and consistency in light management across varying operational conditions.

Optionally, the filter is a bandpass filter. In this regard, the term “bandpass filter” refers to an optical device designed to selectively transmit the light within a specified range of wavelengths while attenuating wavelengths outside that range. Typically, the bandpass filter consists of multiple layers of dielectric coatings or specially formulated materials that allow for precise control over the wavelengths of the light passing through said bandpass filter. In an implementation, the bandpass filter operates by utilizing multiple layers of dielectric coatings or specially formulated materials that selectively transmits the light. When the light enters the optical arrangement, the light passes through the bandpass filter, which allows wavelengths within the specified range to be transmitted to the light-sensitive surface while blocking or reducing an intensity of other wavelengths. This selective transmission is achieved through constructive and destructive interference, ensuring that only the intended wavelengths are transmitted to form the image. Notably, the filter is a narrow bandpass filter, as a narrower bandwidth generally enhances the signal-to-noise ratio. Alternatively, other configurations may also be considered based on application requirements. For example, the bandpass filter may be a dual-bandpass filter, an infrared (IR) bandpass filter (allowing only wavelengths above 700 nanometer to transmit while filtering out lower wavelengths), a visible bandpass filter, and similar. It will be appreciated that the use of the bandpass filter enhances the overall imaging performance by improving colour accuracy and contrast in the images which are being captured by the camera. It will also be appreciated that the attenuation of unwanted wavelengths reduces noise, resulting in the clearer and more precise visual data. This capability is particularly beneficial in applications requiring detailed spectral analysis, for example, such as in fluorescence microscopy, remote sensing, and other imaging techniques where specific light wavelengths are essential for accurate interpretation. A technical effect of incorporating the bandpass filter in the optical arrangement is that it facilitates enhanced image clarity and accuracy by allowing only specific wavelengths of the light to reach the light-sensitive surface, thereby improving colour fidelity and reducing noise.

Optionally, a material of the filter is a glass material. In this regard, the term “glass material” refers to an optically transparent substance, that is designed to transmit the light with minimal absorption and/or scattering. The glass material is often used in optical components (for example, such as lenses, filters, and similar) due to its high durability, chemical resistance, and/or thermal stability. Such properties ensures that the filter maintains its optical properties over time, even when exposed to fluctuating environmental conditions. Examples of the glass material may include, but are not limited to, a borosilicate glass, a crown glass, a fused silica, and similar. It will be appreciated that the glass material can be manufactured with different coatings and treatments to form a highly effective bandpass filter, which allows only particular wavelengths to pass through and be incident on the light-sensitive surface of the image sensor, while attenuating wavelengths of light. Herein, the glass material maintains an optical integrity of the optical arrangement, ensuring consistent filter performance. Optionally, the glass material is planar, ensuring uniform transmission of the light across its surface. The structural rigidity of the glass material enables for precise manufacturing tolerances, optimizing the alignment of the filter within the optical arrangement. A technical effect of utilising the glass material in the filter is that it enables high optical clarity and stability, ensuring precise wavelength filtering and long-term durability of the optical arrangement. This contributes to consistent image quality across varying environmental conditions.

Optionally, the filter is manufactured using hot forming. In this regard, the term “hot forming” refers to a manufacturing process in which materials, such as metals, glass, and similar, are heated to a temperature that is above their recrystallization point to facilitate shaping, molding, and deformation. Herein, the recrystallization point refers to a specific temperature at which the material, particularly metals and some types of glass, undergoes a transformation that allows new grains to form within structure of the material. At this temperature, the material becomes sufficiently soft and ductile, enabling it to be reshaped without breaking. In the optical arrangement, the glass material for the filter is heated to a controlled temperature in the hot forming process, allowing the material to be molded with precise control. This method is used to ensure uniformity and minimal internal stresses within the glass, improving optical clarity and consistency in the filtering performance. It will be appreciated that the utilization of the hot forming enhances the structural integrity of the filter by reducing defects and inclusions that could affect optical performance. Additionally, the capability to mold the glass material with high precision facilitates the production of complex geometries, which can optimize interaction between the light and the filter, thereby improving effectiveness of wavelength selection and transmission. A technical effect of manufacturing the filter using the hot forming is that it enhances the optical performance and structural integrity of the filter by enabling precise shaping and minimizing internal stresses within the glass material.

Optionally, the second surface is curved. In this regard, a curvature of the second surface is precisely designed to interact with the light in a way that optimizes the internal light path. Moreover, the curvature of the second surface is same as or different from the curvature of the first curved surface. When the light enters the optical arrangement and interacts with the second surface which is curved, the curvature can direct or concentrate the light more effectively within the optical arrangement, facilitating efficient transmission and control of the light. This configuration also reduces a risk of the light reflecting back towards the light-sensitive surface, thus lowering the chance of interference and enhancing quality of the image. It will be appreciated that by curving the second surface, the optical arrangement can better manage internal light reflections, directing the light along an optimized path and enhancing overall transmission efficiency. The curved design helps to reduce back reflections towards the light-sensitive surface, reducing unwanted interference and contributing to a clearer, more consistent output of the image. This configuration is advantageous for applications where reliable light control and minimized optical noise are essential. A technical effect of the second surface being curved is that it enhances light management within the optical arrangement by directing internal reflections more effectively, reducing interference with the light-sensitive surface.

Optionally, a curvature of the first curved surface matches a curvature of the second surface. In this regard, the term “curvature” refers to a geometric property of a surface that describes how the surface deviates from being flat. By aligning the curvature, the light can pass more smoothly between the first curved surface and the second surface, minimizing optical aberrations and optimizing the path of the light through the optical arrangement. When the curvature of the first curved surface and the second surface matches, it facilitates accurate focusing of the light, reducing distortions that may occur due to misaligned surfaces. It will also be appreciated that the matching of the curvature of the second surface with the first curved surface, reduces a likelihood of the stray light that degrades the quality of the image, thereby promoting higher contrast and clarity in the image. In an implementation, the matching of the curvature can be achieved through precision manufacturing techniques. The surfaces are designed using optical design software to calculate and optimize their geometrical profiles. During production, processes for example, such as grinding, molding, and similar, are utilized to ensure that both surfaces have the intended curvature, allowing them to interact with the light effectively. A technical effect of having the curvature of the first curved surface match the curvature of the second surface is that it facilitates a seamless transition of the light between the two said surfaces. This minimizes optical losses associated with reflections and misalignment, thereby enhancing overall transmission efficiency of the light.

Optionally, a radius of the curvature of at least one of: the first curved surface, the second surface lies in a range from 1 millimetre to 300 millimetres. In this regard, the term “radius” refers to a distance from a centre of the curvature of the at least one of: the first curved surface, the second surface to any point on an arc of the curvature itself. The radius of the curvature of at least one of: the first curved surface, the second surface may, for example, lie in a range from 1 millimetre, 2, 3, 5, 7, 10, 15, 20, 30, 40, 50, 70, 100, 130, 160, 200, 240, or 290 millimetres up to 5, 55, 100, 140, 175, 205, 235, 265, 285, 295, 297, 299, or 300 millimetres. Herein, the radius of the curvature is determined based on the desired optical properties of the optical arrangement. For instance, a radius at lower end of the range (around 1 millimetre) would create a sharper curve, which may be beneficial for focusing the light tightly, while a radius closer to upper end of the range (around 300 millimetres) would provide a more gradual curvature, which could be advantageous for applications that require a broader field of view or less distortion. It will be appreciated that selecting an appropriate radius of the curvature is essential for optimizing behaviour of the light within the optical arrangement. A sharper curvature allows for enhanced light concentration, which can improve ability of the optical arrangement to focus the light on the light-sensitive surface, leading to higher image clarity and better signal detection. Conversely, a more gradual curvature can reduce optical aberrations and improve an overall uniformity of distribution of the light, thus enhancing image quality across a wider field of view. A technical effect of specifying the radius of the curvature within the range of 1 millimetre to 300 millimetres is that it enables for precise control over the light within the optical arrangement, facilitating optimal focusing and distribution of the light.

Optionally, the image sensor further comprises a cover having a cover surface. The term “cover” refers to a protective or a functional layer that encases the image sensor. In the optical arrangement, the cover is designed to provide physical protection to the image senor from environmental factors such as dust, moisture, mechanical damage, and similar. This physical protection ensures consistent performance of the image sensor and longevity of the camera in various operational conditions The term “cover surface” refers to an outermost layer or a face of the cover that directly interacts with the light. Herein, the cover surface is integrated as a part of the image senor. The cover material and design may be selected based on optical requirements, for example, such as transparency, refractive index, anti-reflective properties, and similar, to allow the light to pass efficiently while protecting the image senor. In some implementations, the cover may be designed with specific coatings or structures that enhance capturing of the light, reduce reflections, or selectively filter wavelengths before the light reaches the image senor. It will be appreciated that integrating the cover surface with specific optical properties can significantly enhance the performance of the image senor. By optimizing transmission of the light and reducing the unwanted reflections, the cover not only improves signal quality but also enhances clarity and contrast of the image. A technical effect of the aforementioned feature is that it enables the optical arrangement to maintain optimal functionality across varying environmental conditions, enhancing durability, reliability, and precision in capturing and processing the light.

Optionally, the cover and the cover surface comprises glass. Herein, the term “glass” refers to a an optically transparent material that allows passage of light therethrough. The cover and the cover surface are manufactured using glass, thus allowing the light to pass through the image sensor with minimal interference. The glass material may include specific coatings or treatments, for example, such as anti-reflective ultraviolet-blocking layers, to enhance light transmission, reduce glare, or filter specific wavelengths before the light reaches the image sensor. It will be appreciated that using the glass for the cover and the cover surface effectively reduces reflections at an interface between the cover and the image sensor, thereby enhancing the light transmission and improving overall optical performance. The glass can be treated with anti-reflective coatings that may prevent the stray light from reaching the image sensor. This provides higher quality of the image and increased sensitivity of the image sensor, which is essential for applications requiring accurate and clear detection of the light. It will also be appreciated that utilizing the glass for the cover and the cover surface ensures high optical clarity, which is essential for maintaining an integrity of the light being transmitted. A technical effect of utilizing the glass for the cover and the cover surface is that it enables reliable and efficient transmission of the light to the image sensor, while providing durability and environmental resistance.

The present disclosure also relates to the second and third aspect as described above. Various embodiments and variants disclosed above, with respect to the aforementioned first aspect, apply mutatis mutandis to the aforementioned second and third aspect.

In the second aspect, including the optical arrangement in the camera provides specific benefits such as enhanced light management, precise alignment, and optimized image clarity. By integrating the optical arrangement, the camera can achieve higher precision in capturing images with reduced aberrations, distortions, unwanted reflections, and similar artifacts, which are essential for high-quality imaging applications. Herein, the optical arrangement is implemented within the camera such that said optical arrangement is aligned with the optical axis of the camera and is configured to focus and transmit the light efficiently to the image sensor. This configuration may include components such as lenses, covers, filters, image sensors, and other optical elements that are optimally specified to enhance transmission of the light, filter wavelengths, and reduce reflections. A technical effect of incorporating the optical arrangement into the camera is an improved quality and clarity of the image captured by the camera.

In the second aspect, the term “lens” refers to an optical element composed of one or more transparent materials with surfaces that are shaped to refract, focus, or disperse the light passing through it. Examples of the lens may include, but are not limited to, a convex lens, a concave lens, a plano-convex lens, a biconvex lens, an aspheric lens, a cylindrical lens, a Fresnel lens, and a gradient-index lens. Herein, the lens is arranged precisely in front of the optical arrangement so that its optical axis coincides with that of the optical arrangement. This setup can be achieved through mechanical alignment features (for example, such as mounting grooves or alignment markers) or active alignment processes to achieve the desired axis congruence. By ensuring that both the optical axis of the optical arrangement and the optical axis of the lens are matched, the light path through the optical arrangement becomes predictable and stable, improving the consistency and quality of the light transmission. It will be appreciated that arranging the lens in front of the optical arrangement with coinciding optical axes allows for precise alignment of the light entering the camera, thereby reducing angular distortions and improving clarity of the image. This alignment also minimizes an optical aberrations by directing the light along a stable and uniform path, enhancing the overall accuracy and efficiency of transmission of the light to the image sensor. It will also be appreciated that this configuration provides predictable light behavior across the optical arrangement, which is essential for applications that require high precision in detection of the light or imaging.

Optionally, a design of the lens is based on a curvature of the filter. In this regard, the design of the lens involves analysing the curvature of the filter to determine how it influences displacement of the light. This includes assessing factors such as the radius of curvature and optionally, an angle of incidence of the light as it enters the lens. The lens is then shaped and configured to counteract any distortions caused by the curvature of the filter, which may involve adjusting the focal length, thickness, and surface profiles of the lens. Computational optical design methods may be utilized to simulate and refine the lens profile to ensure it aligns with the filter's optical characteristics. A requirement to design of the lens on the curvature of the filter arises from understanding that optical elements can significantly affect how the light is transmitted and focused. The filter, particularly with curved surfaces, can cause changes in the path of the light rays as they pass through. These changes can lead to optical distortions, aberrations, or a misalignment of the light entering the camera. Therefore, it is essential to design the lens to accommodate these changes to ensure optimal image quality. A technical effect of designing the lens based on the curvature of the filter is that it takes into account different optical displacements (i.e., a change in position and/or direction of the light as it passes through the filter) of the filter.

In the second aspect, the term “light source” refers to a device that emits electromagnetic radiation within visible spectrum, to illuminate a scene or an object for imaging or measurement purposes. Examples of the light source may include, but are not limited to, an incandescent bulb, a light emitting diode, and a fluorescent lamp. Herein, the light is arranged any one of: on top of the lens, below the lens, a side of the lens. The light emitted from the light source travels through the lens, which is designed to refract and direct the light towards the optical arrangement effectively. This arrangement may involve calculations or design considerations to optimize an angle and intensity of the light entering the lens, ensuring that it is adequately focused for imaging purposes. The inclusion of the light source is essential for functionality of the camera. The light source provides the illumination necessary for capturing images. Without sufficient light, the camera would be unable to produce clear and discernible images. The arrangement of the light source to direct the light through the lens ensures that the light is appropriately focused and managed before it reaches the optical arrangement, which is critical for optimizing imaging performance of the camera. A technical effect of this configuration is that it enhances the quality and accuracy of the light transmission to the optical arrangement, thereby improving overall imaging capability of the camera.

Optionally, an operational range of an image sensor comprised in the optical arrangement is from 0.1 metre to 200 metres. In this regard, the term “operational range” refers to a specific distance over which the image sensor can effectively detect and respond to the light. The operational range of the image sensor may, for example, lie in a range from 0.1 metre, 0.2, 0.4, 0.6, 0.9, 1.2, 1.5, 2, 2.5, 3, 4, 5, 7, 9, 12, 15, 20, 25, 30, 40, 50, 70, 100, 130, 160, or 190 metres up to 1 metre, 40, 70, 95, 120, 140, 160, 175, 185, 190, 194, 197, 199, or 200 metres. The image sensor may be designed with sensitivity parameters optimized for detection of the light over the operational range. This may involve selecting appropriate materials and structures that maximize the light absorption and minimize noise. The lens arrangement is used to focus light effectively onto the image sensor across the operational range. This may include specific coatings and optical designs that enhance the light transmission and reduce distortions. Herein, the camera may undergo rigorous calibration and testing to ensure that the image sensor performs reliably across the operational range, adjusting for factors like ambient light conditions, angle of incidence, and other variables. It will be appreciated that defining the operational range of the image sensor enables for versatile applications across various lighting conditions and distances. This broad range enhances capability of the camera to capture high-quality images in diverse environments, including close-up photography and distant subjects. It will also be appreciated that the operational range ensures effective light detection across a spectrum of intensities, which is essential for maintaining clarity and detail of the image. This capability contributes to improved versatility and performance in diverse imaging applications, for example, such as surveillance, scientific imaging, remote sensing, and similar, where both near and far objects need to be effectively captured without compromising performance. A technical effect of defining the operational range of the image sensor from 0.1 metre to 200 metres is that it enhances the adaptability of the optical arrangement, allowing for effective light detection and capturing of the image across varying distances and lighting conditions.

Optionally, the camera comprises at least one of: an indirect-type TOF camera, a direct-type TOF camera, an event camera, a single-wavelength camera.

### Experimental Part

In an exemplary experiment part, an effect of using a filter that comprises a flat surface in comparison to a filter that comprises a first curved surface was assessed within the optical arrangement, to determine a relation of a curvature of the filter to incoherent irradiance distribution and optical displacement. The simulation was conducted using two field point sources positioned at centre and a peripheral edge, respectively, of a field of view of the image to compare the irradiance distribution. Notably, the peripheral edge comprises a bottom edge, wherein the bottom edge refers to a lower boundary of the field of view along a vertical axis. The purpose of said simulation is to compare the performance of the flat bandpass filter with the curved bandpass filter in terms of how each filter affects distribution of the light and an optical alignment. Optionally, the filter is a bandpass filter. Henceforth, for sake of brevity, the filter that comprises the flat surface is interchangeably referred to as “flat bandpass filter” and the filter that comprises the first curved surface is interchangeably referred to as “curved bandpass filter”.

When the flat bandpass filter was used in the optical arrangement, it was observed that the irradiance near the bottom edge of the field of view was less controlled. In this regard, unwanted reflections and a blur effect, especially as we move towards the bottom edge of the field of view. This indicates that the flat bandpass filter does not manage the light as effectively across an entire field of view, causing increased optical noise and scattering, which can degrade quality of the image. At the bottom edge, the flat bandpass filter allows the light rays to disperse or reflect back, creating the unwanted reflections or optical effects that can result in a blurry or less precise image.

When the curved bandpass filter was used in the optical arrangement, the irradiance distribution is more controlled and smooth, particularly towards the bottom edge of the field of view of the image. The curvature of the curved bandpass filter helps to focus the light more evenly across the entire field of view of the image, minimizing the unwanted reflections and aberrations. This resulted in a cleaner, more stable irradiance pattern, reducing optical artifacts that could distort quality of the image, especially near the bottom edge. Hence, the curved bandpass filter effectively directed the light towards the image sensor within the optical arrangement, maintaining a more uniform light intensity across both the centre and the bottom edge of the field of view.

### DETAILED DESCRIPTION OF THE DRAWINGS

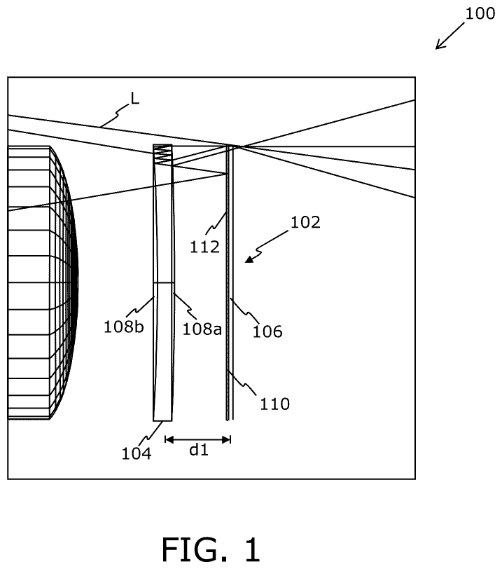

Referring to FIG. 1, illustrated is a schematic illustration of an optical arrangement 100 for reducing reflections in a camera, in accordance with an embodiment of the present disclosure. With reference to FIG. 1, the optical arrangement comprises an image sensor 102 and a filter 104, wherein the image sensor 102 comprises a light-sensitive surface 106. Herein, the filter 104 is arranged at a first distance (depicted as d1) from the light sensitive surface 106 along an optical axis of the optical arrangement 100, wherein the filter 104 comprises: a first curved surface 108a facing the light-sensitive surface 106, and a second surface 108b opposite to the first curved surface 108a. Herein, the light-sensitive surface 106 is configured to receive light (depicted as L) and reflect the received light L towards the filter 104, and wherein the filter 104 is configured to reflect the light L between the first curved surface 108a and the second surface 108b inside the filter 104, whereby reflections between the filter 104 and the light sensitive surface 106 are reduced. Notably, the filter 104 is configured to reduce unintentional reflections between the first curved surface 108a and the second surface 108b which are directed towards the light sensitive surface 106. Optionally, the image sensor 102 further comprises a cover 110 having a cover surface 112. Optionally, the second surface 108b is curved.

FIG. 1 is merely an example, which should not unduly limit the scope of the claims herein. A person skilled in the art will recognize many variations, alternatives, and modifications of embodiments of the present disclosure.

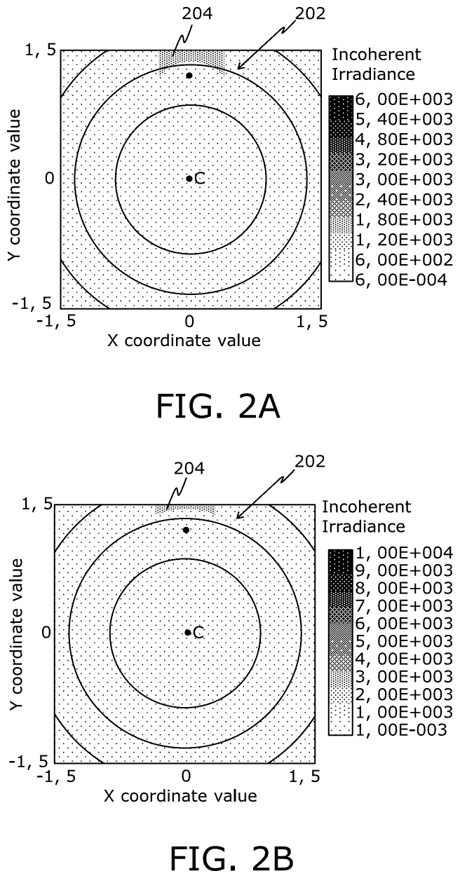

Referring to FIGS. 2A and 2B, illustrated are graphical representations of an exemplary experimentation part conducted for comparing performance of a flat bandpass filter and a curved bandpass filter in terms of an irradiance distribution within an optical arrangement 100, in accordance with an embodiment of the present disclosure. Herein, a vertical axis (depicted as Y-axis) represents spatial Y-coordinate values across a field of view of an image, and a horizontal axis (depicted as X-axis) represents spatial X-coordinate values across the field of view of said image. Herein, a simulation was conducted using two field point sources positioned at a center (labelled as C) and a peripheral edge, respectively, of a field of view of an image to compare the irradiance distribution. Notably, the peripheral edge comprises a bottom edge (depicted as 202), wherein the bottom edge refers to a lower boundary of the field of view along the vertical axis.

With reference to FIG. 2A, when the flat bandpass filter was used in the optical arrangement 100, it was observed that the irradiance near the bottom edge 202 of the field of view was less controlled. In this regard, unwanted reflections and a blur effect (depicted as 204), especially as we move towards the bottom edge 202 of the field of view. This indicates that the flat bandpass filter does not manage the light as effectively across an entire field of view, causing increased optical noise and scattering, which can degrade quality of the image. At the bottom edge 202, the flat bandpass filter allows the light rays to disperse or reflect back, creating the unwanted reflections or optical effects that can result in a blurry or less precise image.

With reference to FIG. 2B, when the curved bandpass filter was used in the optical arrangement, the irradiance distribution is more controlled and smooth, particularly towards the bottom edge 202 of the field of view of the image. The curvature of the curved bandpass filter helps to focus the light more evenly across the entire field of the image, minimizing the unwanted reflections and the blur effect (depicted as 204). This resulted in a cleaner, more stable irradiance pattern, reducing optical artifacts that could distort quality of the image, especially near the bottom edge 202. Hence, the curved bandpass filter effectively directed the light towards the image sensor within the optical arrangement 100, maintaining a more uniform intensity of the light across both the centre C and the bottom edge 202 of the field of view of the image.

Referring to FIG. 3, illustrated is a block diagram of an architecture of a camera 300 comprising an optical arrangement 100 of FIG. 1, in accordance with an embodiment of the present disclosure. With reference to FIG. 3, the camera 300 comprises the optical arrangement 100 of aforementioned first aspect; a lens 302 arranged in front of the optical arrangement 100, wherein an optical axis 304 of the optical arrangement 100 coincides with an optical axis 306 of the lens 302; and a light source 308 that is arranged to emit light, when in use, wherein when in use, the light source 308 emits light, said light passes through the lens 302 and is incident at the optical arrangement 100.

FIG. 3 is merely an example, which should not unduly limit the scope of the claims herein. A person skilled in the art will recognize many variations, alternatives, and modifications of embodiments of the present disclosure.

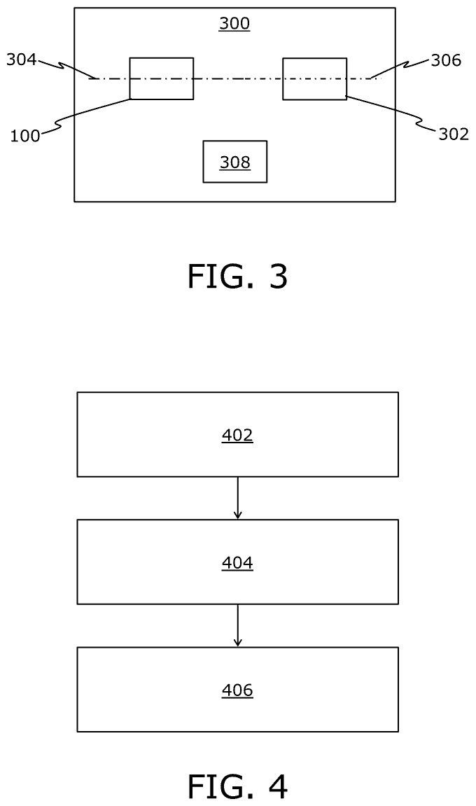

Referring to FIG. 4, illustrated are steps of a method of reducing reflections in a camera, the method implemented by an optical arrangement, in accordance with an embodiment of the present disclosure. At step 402, light is received on a light sensitive surface of an image sensor. At step 404, the light is reflected towards a filter that is arranged at a first distance from the light sensitive surface along an optical axis of the optical arrangement. At step 406, the light is reflected between first curved surface and second surface inside the filter to reduce reflections between the filter and the light-sensitive surface.

The aforementioned steps are only illustrative and other alternatives can also be provided where one or more steps are added, one or more steps are removed, or one or more steps are provided in a different sequence without departing from the scope of the claims herein.

1. An optical arrangement for reducing reflections in a camera, the optical arrangement comprising:
an image sensor comprising a light-sensitive surface; and
a filter arranged at a first distance from the light sensitive surface along an optical axis of the optical arrangement, wherein the filter comprises:
a first curved surface facing the light-sensitive surface, and
a second surface opposite to the first curved surface,
wherein the light-sensitive surface is configured to receive light and reflect the received light towards the filter, and wherein the filter is configured to reflect the light between the first curved surface and the second surface inside the filter, whereby reflections between the filter and the light sensitive surface are reduced.

2. An optical arrangement according to claim 1, wherein the image sensor further comprises a cover having a cover surface.

3. An optical arrangement according to claims 1, wherein the first distance lies in a range from 0.1 millimetres (mm) up to 10 mm.

4. An optical arrangement according to claim 1, wherein the second surface is curved.

5. An optical arrangement according to claim 4, wherein a curvature of the first curved surface matches a curvature of the second surface.

6. An optical arrangement according to claim 4, wherein a radius of the curvature of at least one of: the first curved surface, the second surface lies in a range from 1 millimetre to 300 millimetres.

7. An optical arrangement according to claim 1, wherein the filter is a bandpass filter.

8. An optical arrangement according to claim 1, wherein the camera comprises at least one of: an indirect-type TOF camera, a direct-type TOF camera, an event camera, a single-wavelength camera.

9. An optical arrangement according to claim 1, wherein a material of the filter is a glass material.

10. An optical arrangement according to claim 1, wherein the filter is manufactured using hot forming.

11. An optical arrangement according to claim 1, wherein the cover and the cover surface comprises glass.

12. A camera comprising:
an optical arrangement of claim 1;
a lens arranged in front of the optical arrangement, wherein an optical axis of the optical arrangement coincides with an optical axis of the lens; and
a light source that is arranged to emit light, when in use;
wherein when in use, the light source emits light, said light passes through the lens and is incident at the optical arrangement.

13. A camera according to claim 12, wherein a design of the lens is based on a curvature of the filter.

14. A camera according to claim 12, wherein an operational range of an image sensor comprised in the optical arrangement is from 0.1 metre to 200 metres.

15. A camera according to claim 12, wherein the camera comprises at least one of: an indirect-type TOF camera, a direct-type TOF camera, an event camera, a single-wavelength camera.

16. A method of reducing reflections in a camera, the method implemented by an optical arrangement, wherein the optical arrangement comprises an image sensor comprising a light-sensitive surface, a filter having a first curved surface that faces the light-sensitive surface of the image sensor, and a second surface that is opposite to the first curved surface, the method comprising:
receiving light on the light sensitive surface of the image sensor;
reflecting the light towards the filter that is arranged at a first distance from the light sensitive surface along an optical axis of the optical arrangement; and
reflecting the light between the first curved surface and the second surface inside the filter to reduce reflections between the filter and the light-sensitive surface.
